(19) United States
(12) Patent Application Publication
(10) Pub. No.: US 2019/0070943 A1
(43) Pub. Date: Mar. 7, 2019

(54) WINDOW SURROUND

(71) Applicant: Cadea Gesellschaft für Anwendung und Realisierung Computerunterstützter Systeme mbH, Eichenau (DE)

(72) Inventor: Harald ERTL, Eichenau (DE)

(21) Appl. No.: 16/081,289

(22) PCT Filed: Jan. 20, 2017
(86) PCT No.: PCT/EP2017/051174

§ 371 Date: Aug. 30, 2018

(30) Foreign Application Priority Data
Mar. 4, 2016 (DE) 10 2016 002 684.7

(51) Int. Cl. B60J 10/265; B60J 10/77; B60J 10/88; B60R 13/04

(52) U.S. Cl. CPC B60J 10/265; B60R 13/04; B60J 10/88; B60J 10/77

(57) ABSTRACT

The invention refers to a window surround for a window of a passenger vehicle (1), with at least one seal which comprises one or more sealing profiles (10, 10′, 10″) and with a plastic support profile (8, 12) interacting with the seal and a decorative cover (9, 13) covering the support profile and having a metallic visible surface (11). The object of the present invention is therefore to provide a window surround of the type mentioned above, which is easier to produce while retaining the aforementioned advantages, and therefore the decorative cover (9, 13) is also designed as an injection-molded plastic part, wherein the visible surface (11) of the decorative cover is galvanized.

### CROSS-REFERENCE TO RELATED APPLICATIONS

This application is a U.S. national stage application of International Application No. PCT/EP2017/051174, which has an international filing date of 20 Jan. 2017, and which claims priority to German patent application number DE 10 2016 002 684.7, filed 4 Mar. 2016.

### BACKGROUND OF THE INVENTION

### Field of the Invention

The invention refers to a window surround for a side glazing of a passenger vehicle, with at least one seal comprising one or a plurality of sealing profiles and with a plastic support profile interacting with the seal and a decorative cover covering the support profile and having a metallic visible surface.

### Description of Related Art

For frameless side windows of passenger vehicles, especially coupes, it is preferred that the decorative cover is pulled around the side glazing as gap-free as possible.

Such a window surround is described for example in EP 2 352 658 B1. This known window surround is visually very appealing, because it bridges joints of the support profile with a metal decorative cover and thus makes them invisible. The disadvantage, however, is that the decorative cover must be flanged onto the support profile, which is relatively time-consuming.

### SUMMARY OF THE INVENTION

It is therefore the object of the present invention to provide a window surround of the type mentioned above, which can be produced more cost-effectively and with weight savings while retaining the aforementioned advantages. According to the invention, this object is solved in that the decorative cover is also formed as an injection-molded plastic part, whereby the visible surface of the decorative cover is galvanized. Galvanizing of plastics is now common. The plastic material is germinated, then a copper layer is deposited and then a chromium layer is applied to it. This eliminates the need to flange a metal part onto the support profile as a decorative cover.

According to a preferred embodiment, the support profile and decorative cover can be formed integrally. Such an approach is always advisable if the support profile does not have a too complex shape and the parting planes of the forming tool can be selected in such a way that the visible surface of the decorative cover to be galvanized later is free of a slit. In order to be able to realize even more complex support profiles, a solution in which the decorative cover is firmly bonded to the support profile is particularly preferred. In this way, the tool for the support profile can be formed in such a way that, where the support profile is connected to the decorative cover, there can certainly be a slit in the tool. The resulting burr is covered by firmly bonding the decorative cover. Known methods such as laser welding, friction welding and ultrasonic welding can be used for connecting in a firmly bonded manner.

According to an alternative, it can also be provided that the decorative cover is glued to the support profile. Particularly preferred in cases where the support profile has joints, the decorative cover is dimensioned in such a way that these joints of the support profile are covered. It is particularly preferred if the decorative cover and the support profile are made of ABS plastics.

To achieve optical effects, LEDs can also be arranged on the rear side of the decorative cover. It is especially preferred if the galvanic layer is interrupted in the area of the LEDs. The plastic material is translucent in this case.

The invention also refers to a method for producing a window surround, which is characterized in that the support profile and the decorative cover are injection-molded and are subsequently firmly bonded together and wherein the visible surface of the decorative cover is roughened, germinated and galvanized. In this method, the support profile and decorative cover are first joined together and then the visible surface of the decorative cover is galvanized. Instead of welding the support profile and decorative cover, the support profile and decorative cover can also be joined together in another way or even produced in one piece.

In one variant of the method it is provided that the support profile and decorative cover are injection-molded, then the decorative cover is roughened, germinated and galvanized, then the decorative cover and support profile are firmly bonded to one another or glued together. In this method, the decorative cover is first galvanized, then the support profile and the decorative cover are joined.

Laser welding or ultrasonic welding are suitable methods for joining the support profile and the decorative cover.

### BRIEF DESCRIPTION OF THE DRAWINGS

In the following, an embodiment of the invention is explained in more detail using a drawing.

FIG. 1 shows a passenger vehicle in a side view;

FIG. 2 shows a section through the window surround of the passenger vehicle according to FIG. 1 along the line II-II;

FIG. 3 shows a section through the window surround along the line III-III;

FIG. 4 shows a section through the window surround along line IV-IV;

FIG. 5 shows a section through the window surround along the line V-V;

FIG. 6 shows a section through the window surround along line VI-VI; and

FIG. 7 shows a section through the window surround along line VII-VII.

### DETAILED DESCRIPTION OF THE INVENTION AND SPECIFIC EMBODIMENTS THEREOF

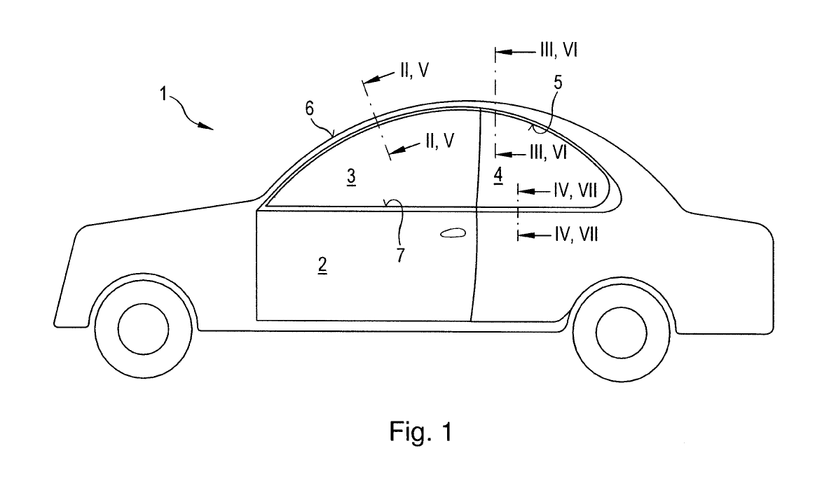

The passenger vehicle shown in FIG. 1 is a coupe 1 with a door 2 and a side window 3, which can be lowered into door 1. Behind door 2 there is a fixed side window 4. Both side windows 3 and 4 are surrounded by a window surround 5, which extends along the upper roof column 6 and along the lower edge of window 4 or shaft 7 of door 2 to the front area of the vehicle.

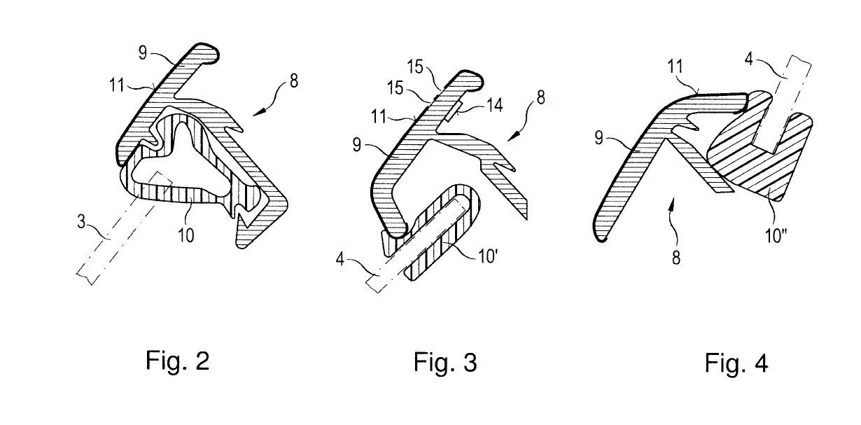

Looking at FIG. 2, the cross-section through the window surround can be seen in the area of section II-II. This cross-section shows the side window 3 and a support profile 8 for the various seals used to seal the windows against the vehicle. For the sake of clarity, only the seal 10 is shown in FIG. 2, which interacts with the vertically movable side window 3. The other seals are omitted for clarity.

The support profile 8 has a decorative cover 9 on its side facing the outside of the vehicle body, which is formed integrally with the support profile 8. The decorative cover 9 is galvanized on its outside, i.e. its visible surface. Strictly speaking, a metal layer 11 is deposited by a galvanization process.

FIG. 3 shows the window surround in a sectional view along the line III-III, i.e. in the area of the fixed side window 4. There, the edge of the side window is molded around with a seal 10′. The seal 10′ seals the side window against the decorative cover 9. In this area, the support profile 8 is also formed integrally with the decorative cover 9, which is also provided in this area with the metallic layer 11 applied by galvanization.

LEDs 14 are arranged on the rear side of the decorative cover, while the metal layer 11 has interruptions. In this case, the plastic material is translucent so that lighting effects can be achieved.

The same also applies to the window surround in the area of the cross-sectional view IV-IV, i.e. in the area of the shaft. The molding 10′ is used for fixing the support profile.

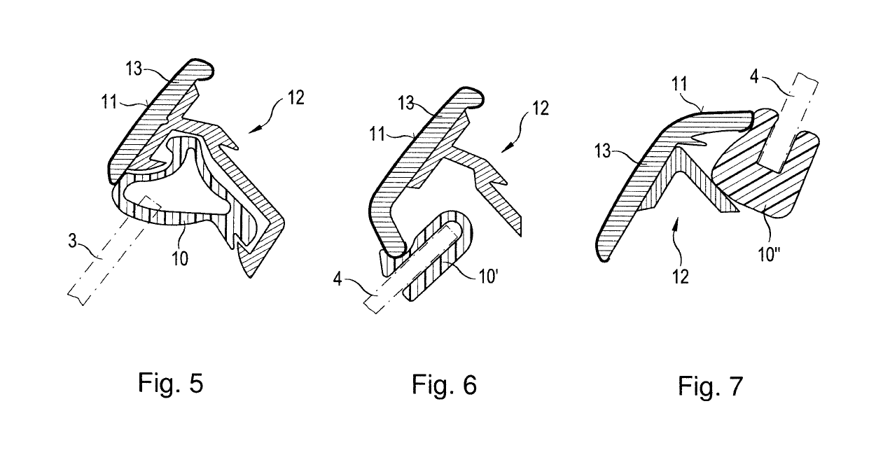

FIGS. 5 to 7 shows a variant of the window surround to FIGS. 2 to 4. As can be seen from the drawings, the main difference is that the support profile 12 and the decorative cover 13 are separate components which are connected to each other. Strictly speaking, in the embodiment shown here, the support profile 12 and the decorative cover 13 are firmly bonded to one another by conventional welding processes, such as ultrasonic welding or laser welding. Otherwise the arrangements do not differ from those shown in FIGS. 2 to 4.

In the following, two methods for producing a window surround according to the invention are explained in more detail.

For the window surround as shown in FIGS. 2 to 4, the support profile and decorative cover are injection-molded in one piece. The visible surface of the screen is then roughened and germinated in the conventional way, after which a chrome layer 11 is applied by galvanization.

In contrast hereto, in the embodiment according to FIGS. 5 to 7, the support profile 12 is injection-molded as a separate part, as is the decorative cover 13. Now the decorative cover 13 can be galvanized without the support profile. Afterwards, the decorative cover can either be glued to the support profile or firmly bonded to the support profile by ultrasonic welding or another suitable method. The advantage here is that reinforcing ribs can be inserted without the risk that these may appear on the upper side.

Advantage of two parts: Insertion of reinforcing rib without risk of optical markings on the surface.

The method according to the invention allows the simple production of a window surround without the need for flanging a metal decorative cover.

1. Window surround for a window of a passenger vehicle, having at least one seal comprising one or more sealing profiles and having a plastic support profile interacting with the seal, and a decorative cover with a metallic visible surface covering the support profile, characterized in that the decorative cover comprises an injection-molded plastic part, the support profile and the decorative cover being one of firmly bonded to one another or formed in one piece, and the visible surface of the decorative cover has a galvanic layer thereon.

2. Window surround according to claim 1, characterized in that the decorative cover is glued to the support profile.

3. Window surround according to claim 1 or claim 2, characterized in that the decorative cover covers possible joints of the support profile.

4. Window surround according to claim 1 or claim 2, characterized in that the decorative cover and support profile comprise an ABS plastic material.

5. Window surround according to claim 1 or claim 2, characterized in that light elements are arranged on the side of the decorative cover facing the vehicle.

6. Window surround according to claim 1 or claim 2, characterized in that the galvanic layer on the visible surface of the decorative cover has interruptions therein and the decorative cover itself comprises a translucent plastic material.

7. Method for producing a window surround according to claim 1 or claim 2, characterized in that the support profile and the decorative cover are injection-molded and are subsequently firmly bonded together and in that the visible surface of the decorative cover is roughened, germinated and galvanized.

8. Method according to claim 1 or claim 2, characterized in that the support profile and the decorative cover are injection-molded, after which the decorative cover is roughened, germinated and galvanized, after which the decorative cover and the support profile are firmly bonded to one another or glued together.

9. Method according to claim 8, characterized in that the support profile and decorative cover are joined together by laser welding or ultrasonic welding.

10. Window surround according to claim 3, characterized in that the decorative cover and support profile comprise an ABS plastic material.

11. Window surround according to claim 1 or claim 2, characterized in that the decorative cover and support profile consist of an ABS plastic material.

12. Window surround according to claim 3, characterized in that light elements are arranged on the side of the decorative cover facing the vehicle.

13. Window surround according to claim 5, wherein the light elements comprise LEDs.

14. Window surround according to claim 5, characterized in that the galvanic layer on the visible surface of the decorative cover has interruptions therein and the decorative cover itself comprises a translucent plastic material.

15. Method according to claim 7, characterized in that the support profile and the decorative cover are injection-molded, after which the decorative cover is roughened, germinated and galvanized, after which the decorative cover and the support profile are firmly bonded to one another or glued together.
